(19) United States
(12) Patent Application Publication
(10) Pub. No.: US 2011/0019500 A1
(43) Pub. Date: Jan. 27, 2011

(54) METHOD, SYSTEM AND LOGGING TOOL FOR ESTIMATING PERMEABILITY OF A FORMATION

(75) Inventors: Boris Danylovich Plyushchenkov, Moscow (RU); Anatoly Alexeevich Nikitin, Moscow (RU); Marwan Charara, Moscow (RU)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: SCHLUMBERGER TECHNOLOGY CORPORATION, Cambridge, MA (US)

(21) Appl. No.: 12/526,154

(22) PCT Filed: Feb. 6, 2007
(86) PCT No.: PCT/RU2007/000057

§ 371 Date: Oct. 11, 2010

(51) Int. Cl. G01V 1/50

(52) U.S. Cl. 367/31

(57) ABSTRACT

The invention relates to the methods for determining the permeability of a geological formation saturated with a liquid and provides for a method, a system and a logging tool for estimating permeability. The method comprises exciting a formation with acoustic energy pulses propagating into the formation, measuring the acoustic response signals produced by the acoustic exciting and the electromagnetic signals produced by said acoustic energy pulses within the formation and separating components from said measured acoustic response signals and said measured electromagnetic signals representing Stoneley waves propagating through the formation. The acoustic response signals and electromagnetic signals representing Stoneley waves propagating through the formation are synthesized. The separated acoustic response signal and electromagnetic signal components and the synthesized Stoneley wave signals are compared. The permeability is determined from differences between the synthesized Stoneley wave signals and the separated acoustic response signal and electromagnetic signal components.

### FIELD OF THE INVENTION

The invention relates to methods for determining the permeability of a geological formation saturated with a liquid by processing signals recorded by a wellbore logging instrument.

### BACKGROUND ART

Acoustic evaluation of rock properties, and in particular the mobility (m) (m=κ₀/η, where η is the shear viscosity of pore fluid, and κ₀ is the rock permeability), in the formation surrounding borehole is very important for exploration and production in the petroleum industry. Direct measurements of the mobility using the core sample analysis techniques are expensive and laborious. It is well known that both the phase velocity and attenuation of low-frequency tube waves (Stoneley wave, about 1 kHz) generated and recorded by classical acoustic logging are correlated to mobility of borehole environment. Based on Biot's theory (see, for example, M. A. Biot, “Mechanics of deformation and acoustic propagation in porous media”, J. Appl. Phys., 33, 4, 1482-1498, 1962) for the pressure point source in an uncased borehole surrounded by a uniform porous solid, for the case of open pores on the borehole wall (see for example, in S. K. Chang, H.-L. Liu, and D. L. Johnson, “Low-frequency waves in permeable rocks”, Geophysics, 53, 4, 519-527, 1988), and for mudcake at the borehole wall (for example see in H.-L. Liu and D. L. Johnson, “Effects of an elastic membrane on tube waves in permeable formations”, J. Acoust. Soc. Am., 101, 6, 3322-3329, 1997), the complex valued expressions for the axial component of the wave vector of low-frequency tube wave were constructed. These expressions became the basis for described in D. Brie, T. Endo, D. L. Johnson, F. Pampuri, “Quantitative formation permeability evaluation from Stoneley waves”, SPE 49131, 1-12 1998, methodology of formation mobility evaluation from acoustic logging data, but it requires at least 10% porosity to achieve an acceptable accuracy error level. Our proposed apparatus and methods of interpretation overcome all these limitations.

In porous materials saturated by a fluid electrolyte, mechanical and electromagnetic disturbances are interdependent. The mechanical disturbance generates electromagnetic field that affects propagation of the former, and vice versa (so called electrokinetic effect). The initial reason for the interference consists in adsorption of excess charge from pore electrolyte into very thin (relative the pore size) surface layer of the frame, so called an adsorbed layer. In the absence of perturbation, this layer is electrically counterbalanced by distributed in adjacent fluid mobile ions of opposite charge. The region of fluid that balances the charges of the adsorbed layer is called the diffusive layer (its width is much more than the adsorbed layer's one). The adsorbed layer and the diffusive layer together constitute an electrical double layer. The surface density of the adsorbed charge is determined by physicochemical properties of the frame material and the pore fluid. The mechanical perturbation moves the pore fluid relative the frame and thereby moves mobile charges of the diffusive layer, i.e. a streaming current of these charges appears. It operates as the current source in the Maxwell equations, generating an electromagnetic field. And vice versa, the electrical component of electromagnetic perturbation acting on these charges moves the pore fluid relative the skeleton. In “Governing equations for the coupled electromagnetics and acoustics of porous media”, Phys. Rev. B., Condensed Matter, 50, 15678-15696, 1994, Steven R. Pride formulated the equations describing the propagation of interdependent acoustic and electromagnetic perturbations in such media. The system of Pride's macroscopic equations in frequency representation consists in the coupling of the Maxwell equations and Biot's equations in the following way. The current density, in Maxwell equations, is equal to the sum of the conduction current density, displacement current density and the density of streaming current. In Biot's equations, describing the pore fluid motion, the additional term appears equal to the product of the charge density of diffusive part of double layer (q) and the electric field strength (E). The streaming current density is equal to the sum of the product of the same charge density and velocity of porous fluid relative the skeleton multiplied by porosity (φ) and the product of “electroosmotic” conductivity due to electrically-induced streaming (convection) of the excess double-layer ions and the electric field strength multiplied by ratio of porosity to tortuosity (α_{∞}). All coefficients of this system are determined through the parameters, which can be defined experimentally or theoretically. These equations together with the relations defining their coefficients will be named below as Pride's model.

U.S. Pat. No. 3,599,085 (Semmelink) describes the method in which a sonic source is lowered down a borehole and used to emit low frequency sound waves. Electrokinetic effects in the surrounding fluid-saturated rock cause an oscillating electric field in this and is measured at least two locations close to the source by contact pad touching the borehole wall. The ratio of the measured potentials to the electrokinetic skin depth is said to be related to provide a permeability estimation of the formation.

U.S. Pat. No. 4,427,944 (Chandler) describes the tool which injects fluid at high pressure of alternating polarity to the formation and measurement of the generated transient streaming potentials in the time domain to estimate the characteristic response time which is inversely proportional to the formation permeability in accordance with his articles (for example, R. N. Chandler, 1981, “Transient streaming potential measurements on fluid-saturated porous structures: an experimental verification of Biot's slow wave in the quasi-static limit,” J. Acoust. Soc. Am., 70, 116-121).

U.S. Pat. No. 5,417,104 (Wong) describes a method whereby pressure pulses of fixed frequency are emitted from a downhole source and the resulting electrokinetic potentials measured. An electrical source of fixed frequency is then used to excite electro-osmotic signals and the pressure response measured. Using both responses together, the permeability is then deduced, provided the electrical conductivity of the rock is also separately measured.

U.S. Pat. No. 5,503,001 (Wong) is a continuation of the patent 5,417,104 and tries to overcome many drawbacks of the previous patent. It is claimed, that using several frequencies enhance the results and using higher frequencies will speed up the measurements. It is acknowledged that not taking into account the mudcake give erroneous results in determining the permeability. It is claimed that by using a pad tool with several pressure sensors and electrodes between the differential pressure sources will diminish the error.

U.S. Pat. No. 5,519,322 (Pozzi et al.) describes a method to measure properly the electrokinetic potential induced by a pressure excitation. It is said that measuring the electrokinetic potential to be detected is very small and doing it by the mean of electrodes is not reliable due to the background noise. It is claimed that the proper way to do it, is by mean of the measurement of the magnetic field.

U.S. Pat. No. 4,904,942 (Thompson) describes several arrangements for recording electrokinetic signals from subsurface rocks mainly with the electrodes measuring the signals at or close to the earth's surface but including use of acoustic source mounted on a downhole tool. There is no indication of permeability being deduced. A further related (inverse) method is described in U.S. Pat. No. 5,877,995, which contains several arrangements for setting out electrical sources and acoustic receivers (geophones) in order to measure electro-acoustic signals induced in subsurface rocks.

U.S. Pat. No. 6,225,806 B1 (Millar et al.) describes an apparatus for enhancing the acoustic-electric measurements where a acoustic source with two frequencies radiates radially an acoustic signal within the borehole and the electric signals are recorded by a pair of electrodes above and below the seismic source. It is claimed that by using a centered acoustic source in the borehole, it allows to do a continuous logging measurement. The formulas for permeability calculation are given without any justifications. As evident from published later report G. Kobayashi, T. Toshioka, T. Takahashi, J. Millar and R. Clarke, 2002, “Development of a practical EKL (electrokinetic logging) system,” SPWLA 43^{rd} Annual Logging Symposium, Jun. 2-5, 2002, 1-6, explaining this patent, its authors used the 1D-model for streaming potential phenomena (transient phenomenon), suggested earlier by R. N. Chandler, as a basis for permeability determination without any argument for its applicability. It is obviously nonsense, as it is commonly agreed now that the acoustic-electric phenomenon is described by Pride's equations. U.S. Pat. No. 6,842,697 B1 is a minor extension of previous patent.

U.S. Pat. No. 5,841,280 (Yu et al.) describes a method and an apparatus for a combined acoustic and electric logging measurements for determination of porosity and conductivity of pore fluid of the rock surrounding the borehole. The apparatus consists in a classical acoustic logging with arrangements of acoustic receivers and electrodes to measure respectively, acoustic and seismoelectric signals. The method doesn't mention any determination of the permeability parameter. They use Pride's equations under the assumption that electromagnetic field is quasi-stationary overall to derive an approximate analytical expression for the ratio R_{E}(ω) of Fourier transform of axial component of electric intensity (Ê^{z}(ω)) to Fourier transform of the pressure field P(t) (\hat{P}(ω)) in receiving point in borehole. This approximation is valid for Stoneley waves for frequencies much less than Biot's frequency and for the case where the borehole wall is assumed having no mudcake. Formula for R_{E}(ω) is claimed. In the patent, product of R_{E}(ω) and Fourier transform of the registered pressure is named a synthetic electric signal. Assuming that all parameters of the model, except for porosity and conductivity of pore fluid, are known, unknown values are determined by trial-and-error method to achieve minimal difference between the synthetic and registered curves for Ê^{z}(ω).

The apparatus and methods described by the above patents (U.S. Pat. No. 3,599,085; U.S. Pat. No. 4,427,944; U.S. Pat. No. 5,417,104; U.S. Pat. No. 5,503,001; U.S. Pat. No. 5,519,322) contain many disadvantages and drawbacks. The apparatus using tool pads on the borehole wall and the methods using the electrokinetic transient potential (streaming potential) are known to be very slow and to have problems to transmit the pressure pulse through the mudcake. They cannot constitute a tool for doing a continuous measurement of permeability. The apparatus and methods using the electrokinetic dynamical potential (electroacoustic) have the possibility to measure the permeability continuously. As the electrokinetic signal is very low, U.S. Pat. No. 5,519,322 taught us that the measurements using only electrodes such as in U.S. Pat. No. 6,225,806 B1 or U.S. Pat. No. 5,841,280 are in practice unfeasible because they are subject to the environmental noise. Moreover, the methods not using the correct description of the phenomena by using Pride's equations such as U.S. Pat. No. 6,225,806 B1, are unable to determine the petrophysical properties of the formation surrounding the borehole; nor the methods not taking into account the presence of the mudcake, which is at the borehole wall in general case, such as U.S. Pat. No. 5,841,280. Methods using only the ratio R_{E}(ω) would lead to solutions containing many parameters to be determined at the same time, and some of them, very difficult to determine in practice such as ζ potential.

### SUMMARY OF THE INVENTION

The purpose of this invention is to propose a method and a system that overcome all the mentioned drawbacks above.

In a first aspect the invention provides a method for estimating permeability of a formation. The method comprises exciting the formation with acoustic energy pulses propagating into said formation. The acoustic energy pulses comprise Stoneley waves. The acoustic response signals produced by the acoustic exciting and the electromagnetic signals produced by said acoustic energy pulses within the formation are measured. The method further comprises separating components from said measured acoustic response signals and said measured electromagnetic signals representing Stoneley waves propagating through said formation. The acoustic response signals and electromagnetic signals representing Stoneley waves propagating through said formation are synthesized using an initial value of the permeability. A difference is determined between said separated acoustic response signal and electromagnetic signal components and said synthesized Stoneley wave signals. The initial values of permeability is adjusted, and the steps of synthesizing the acoustic response signals and electromagnetic signals representing Stoneley waves propagating through the formation, determining the difference and adjusting the value of permeability are repeated until the difference reaches a minimum value. The adjusted value of permeability which results in the difference being at the minimum is taken as the formation permeability.

In a first preferred embodiment the acoustic energy pulses are generated at a logging tool positioned within a borehole surrounded by the formation.

In a second preferred embodiment the electromagnetic signals are magnetic signals.

In a third preferred embodiment the electromagnetic signals are electric signals.

In a fourth preferred embodiment the electromagnetic signals are both magnetic signals and electric signals.

In a fifth preferred embodiment the acoustic energy pulses further comprise compressional waves.

In a sixth preferred embodiment the acoustic energy pulses further comprise shear waves.

In a second aspect, the invention provides a system for estimating permeability of a formation surrounding a borehole. The system comprises a logging tool to be lowered into the borehole. An acoustic energy source located on the logging tool allows to excite the formation with the acoustic energy pulses propagating within the formation. The acoustic energy pulses comprise Stoneley waves. An array of acoustic receivers allows to measure the acoustic response signals produced by the acoustic energy pulses within the formation. The system further comprises an array of electromagnetic receivers. The electromagnetic receivers allow to measure an electromagnetic signal produced by the acoustic energy pulses within the formation. Processing means allows to analyze the measured signals so as to estimate the permeability of the formation.

In a seventh preferred embodiment the electromagnetic receiver is a magnetic receiver allowing to measure a magnetic signal produced by the acoustic energy pulses within the formation.

In an eighth preferred embodiment the electromagnetic receiver is an electric receiver allowing to measure an electric signal produced by the acoustic energy pulses within the formation.

In a ninth preferred embodiment the electromagnetic receiver consists of an electric receiver allowing to measure an electric signal produced by the acoustic energy pulses within the formation and a magnetic receiver allowing to measure a magnetic signal produced by the acoustic energy pulses within the formation.

In a tenth preferred embodiment the electric receivers are electrodes.

In an eleventh preferred embodiment the magnetic receivers are coils.

In a third aspect, the invention provides a logging tool for estimating permeability of a formation surrounding a borehole. The logging tool comprises an elongated mandrel covered by an insulated material or made with a non-conductive material. At least one low-frequency monopole and an array of pressure sensors and coils with ferrite cores are positioned at axially spaced apart locations along the mandrel and are separated by means of acoustic and electric insulators. The coils have shape of series-connected toroid pieces disposed in a circle around the mandrel. The coils can be disposed between azimuthally equally spaced pressure sensors. The electrodes are positioned at axially spaced apart locations from the acoustic energy source so that pressure sensors are disposed in the middle between two adjacent electrodes.

In a twelfth preferred embodiment the logging tool further comprises a high frequency monopole.

In a thirteenth preferred embodiment the logging tool further comprises a dipole emitter.

In a fourteenth preferred embodiment the distance in the circle between the neighboring ends of ferrite cores is more than diameter of pressure sensors and the ferrite core radius is more than the height on which these sensors tower above the surface of the tool.

In a fifteen preferred embodiment only a portion of the mandrel on which the electrodes are disposed is covered by an insulated material or made with a non-conductive material.

In a sixteen preferred embodiment a nuclear logging block is disposed below a low-frequency monopole.

Other aspects and advantages of the invention will be apparent from the following description and the appended claims.

### BRIEF DESCRIPTION OF THE DRAWINGS

FIG. 1 shows an example of acoustic/electromagnetic logging tool according to the invention;

FIG. 2 shows an enlarged cross-section of the logging tool of FIG. 1, in particular, an arrangement of pressure sensors and coils;

FIG. 3 shows the curves of the frequency dependence of the ratio EP or HP for permeable formations for the case of open pores;

FIG. 4 shows the curves of the frequency dependence of the ratio EP or HP for permeable formations for the case of sealed pores;

FIG. 5 shows the curves of the frequency dependence of the ratio EP or HP for weakly permeable formations for the case of open pores;

FIG. 6 shows the curves of the frequency dependence of the ratio EP or HP for wealdy permeable formations for the case of sealed pores.

### DESCRIPTION OF THE PREFERRED EMBODIMENT OF THE INVENTION

Acoustically exciting a formation generates an electromagnetic signal that comprises an electric signal and/or a magnetic signal. An electric field or a difference of electrical potentials may be measured, thus allowing to measure the electric signal. Alternatively, a magnetic field is measured, thus allowing to measure the magnetic signal. Alternatively, both the electric field and the electromagnetic field may be measured.

In the present description, the term “electromagnetic” may designate an electric signal produced by an acoustic signal or a magnetic signal produced by the acoustic signal.

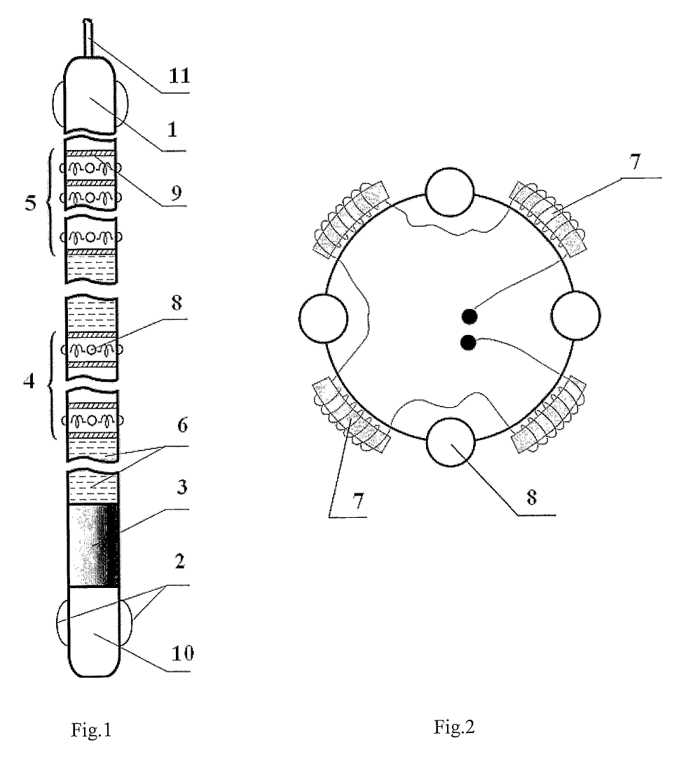

FIG. 1 schematically illustrates an example of a logging tool according to the present invention. It is suggested to use a conventional acoustic logging device (ALD) (for example the eight-receiver Schlumberger STD-A sonic tool according to C. F. Morris, T. M. Little, and W. Letton, 1984, “A new sonic array tool for full-waveform logging,” Presented at the 59^{th} Ann. Tech. Conf. and Exhibition, Soc. Petr. Eng., paper SPE-13285) with minimal modifications as an acoustic-electromagnetic logging device (AEMLD). The tool according to the invention allows to estimate permeability of a formation surrounding a borehole and includes an elongated mandrel 1 with centralizers 2 and contains a transmitter block 3 with at least one acoustic energy source (transmitter) that periodically emits acoustic energy pulses and arrays of acoustic and electromagnetic receiver sections 4 and 5, positioned as axially spaced along the mandrel and separated by means of acoustic and electric insulators 6. Each acoustic receiver contains four or eight pressure sensors azimuthally equally spaced. These pressure sensors (for example, piezoceramic) are connected to amplifiers, outputs of which are connected to the telemetry/controller unit for conditioning and transmission of the voltage measurements to the surface electronics for recording and interpretation in order to determine one or more specific characteristics of acoustic waves propagated in and around the fluid filled borehole. Typical ALD includes both monopole and dipole acoustic transmitters in order to excite acoustic energy pulses to the fluid-filled wellbore and to the earth formations, an array of receivers allowing detection of acoustic waves propagated in and around the liquid-filled wellbore and/or propagated through the earth formation, and down-hole power supplies and electronic modules to controllably operate the transmitters, and to receive the detected acoustic waves and process the acquired data for transmission to the earth's surface.

During operation of the acoustic wellbore logging instrument, the transmitter generates acoustic waves, which travel to the rock formation through the fluid filled wellbore. The propagation of acoustic waves in a liquid-filled wellbore is a complex phenomenon and is affected by the mechanical properties of several separate acoustical domains, including the earth formation, the wellbore liquid column, and the well logging instrument itself. The acoustic wave emanating from the transmitter passes through the liquid and impinges on the wellbore wall. This generates compressional acoustic waves, shear acoustic waves, which travel through the earth formation, surface waves, which travel along the wellbore wall, and guided waves exited by them, which travel within the mud column.

The transmitter block 3 of the proposed AEMLD should have a low-frequency monopole (fpeak=600-1000 Hz), which is the main source for Stoneley wave generation. It can further have two different acoustic emitters:—A high-frequency monopole (fpeak≈20 kHz). It is used for generation of fast compression wave (P₁—wave), and direct measurement of its phase velocity (slowness) through the time of the first arrival;

A dipole emitter (fpeak=5-10 kHz). It is used for generation of wave train without P₁—wave, so allowing to directly measure shear wave velocity (slowness) through the time of the first arrival, as in this case the P1 mode is absent in wave train.

The transmitters are periodically actuated and excite the acoustic energy impulses into a fluid filling wellbore. The acoustic energy impulses travel through the mud and eventually reach the wellbore wall where they interact with it and propagate along the earth formations forming the wellbore wall excited electromagnetic field in formation. Eventually some of the acoustic and electromagnetic energy reaches the electromagnetic receivers, where it is detected and converted into electrical signals. The receivers are electrically connected to a telemetry/controller unit, which can format the signals for transmission to a surface electronics unit for recording and interpretation. The telemetry/controller unit may itself include suitable recording devices (not shown separately) for storing the receiver signals until the instrument is withdrawn from the wellbore.

For waveform measurement of pressure P(t) and azimuth component of magnetic intensity H^{θ}(t), the tool includes connected the identical coils with ferrite core 7 having shape of toroid piece disposed in a circle between pressure sensors 8 (FIG. 1 and FIG. 2). At that (see FIG. 2), the distance in the circle between the neighboring ends of ferrite cores 7 is more than diameter of pressure sensors 8 and the ferrite core radius is more than height on which these sensors tower above a surface of the tool. These conditions provide effective penetration of magnetic field inside of coils and due to the fact that the multilayered winding and the ferrite cores with relative magnetic permeability of the order 10⁵-10⁶ can be used, it is possible to provide a level of an induced voltage values acceptable for amplification (registration) on output of these consistently connected coils by means of proper differential amplifier for amplitude of radial displacement of a low-frequency monopole emitter being sufficient for practical realization (above or equal 1 μm). This voltage is proportional to the value of magnetic intensity in pressure sensor point.

For electrical (E^{z}(t)) measurements, the tool includes electrodes 9, which are positioned at axially spaced locations from the transmitter. The part of the instrument mandrel on which the electrodes are disposed includes an electrically insulating housing (not shown separately), which can be made from fiberglass or similar material, to enable the electrodes to detect electrical voltages from within the wellbore. The electrodes can be of any type well known in the art for detecting electrical voltages from within the wellbore. In FIG. 1 the electrodes 9 are shown as conducting rings and the mandrel should be insulated. Each pair of adjacent electrodes is connected with differential amplifier. The voltage between the electrodes being divided by the distance between them gives the intensity of the axial component of the electric field in a point of an arrangement of the acoustic receiver, which are placed in the middle of the rings pair.

Receiver Section 4 or 5 consists of eight or sixteen acoustic and magnetic receiver sections (P-H receivers) (see FIG. 2) locating at ˜15 cm distance from each other and nine or seventeen conductive rings. Its lower P-H receiver is disposed at ˜2 m distance from transmitter block 3. Receiver Section 4 contains two P-H receivers (˜50 cm between them) and two conductive rings installed at ˜5 cm from the P-H receiver. Its lower P-H receiver is disposed at ˜1 m distance from transmitter block 3. The tool may further comprise a nuclear logging block 10 for density measurements below the transmitter block. The tool can be lowered and withdrawn from a wellbore drilled through earth formation by means of an armored electrical cable 11. The positions of the voltage amplifier modules, of the dial faces block of log data, the control box for emitters, and Mud Δt Measurement Section are not shown on the drawings.

Measurements of a magnetic field in a well are less sensitive to noise in comparison with measurements of an electric field. Nevertheless, it is preferable to use both measurements for the following reasons:
it allows facilitating calibration of the measuring equipment;
comparison of HP (f) and EP (f) curves (their definition will be given below) obtained as the result of measurements (they should coincide theoretically) allows to smooth more reliably the bursts arising on these curves due to noise perturbations arising during measurements of H^{θ}(t) and E^{z}(t). (This smoothing procedure is necessary for accuracy increase of mobility determination.)

Numerical experiments studying the influence of formation mobility on propagation of electromagnetic waves in formation surrounding borehole has shown the following:
Stoneley waves and normal waves are the most sensitive to permeability in wide range of its values;
The frequency dependence of the ratio R_{H}(ω) of complex-valued amplitude of Ĥ^{θ}(ω) (Fourier transform on time of azimuth component of magnetic field intensity) Stoneley wave to complex-valued amplitude of \hat{P} (Fourier transform on time of pressure) Stoneley wave and the frequency dependence of the ratio R_{E}(ω) of complex-valued amplitude of Ê^{z}(ω) (Fourier transform on time of Stoneley wave of axial component of electric field intensity) to complex-valued amplitude of \hat{P} (Fourier transform on time of pressure) Stoneley wave do carry important information on mobility and mudcake stiffness, and the curves of the frequency dependence of the ratio HP=Re (R_{H}(ω))/Im(R_{H}(ω)) and the ratio EP=Re(R_{E}(ω))/Im(R_{E}(ω)) feel them well over wide range of their values. The ratio of the real to the imaginary part of R_{E}(ω) for the Stoneley waves simplifies greatly the solution and diminishes the number of parameters. It can be as well for the magnetic field over the pressure field, or both at the same time.

Analysis of numerical modeling results has shown that for typical formations and borehole acoustic acquisition frequency bands, the influence of electromagnetic waves exited by acoustic waves on the latter is negligibly small. Therefore, Pride's system splits into Biot's equations and the Maxwell equations with only external current density, determined by the velocity of movement of the pore fluid relatively the skeleton. This allowed to derive the approximate analytical expressions for R_{H}(ω) and HP(ω), also for R_{E}(ω) and EP(ω) covering extreme cases, i.e. for open and sealed wall pores of an uncased borehole, namely:

For open pores:

$${R}_{H} \approx - i \frac{φ}{{α}_{∞}} \frac{{ɛ}_{0} {ɛ}_{f} ζ}{η} ( 1 - \frac{i}{{M}_{b}} \frac{ω}{{ω}_{b}} ) {I}_{c}^{H} , \\ where {I}_{c}^{H} \approx \frac{{σ}_{b} {I}_{1} ( {k}_{St} {r}_{d} ) / {I}_{0} ( {k}_{St} {r}_{d} )}{\frac{1}{2} {σ}_{b} {k}_{fe} {r}_{b} {K}_{0} ( {k}_{fe} {r}_{b} ) / {K}_{1} ( {k}_{fe} {r}_{b} ) + σ} , \\ {k}_{fe} = \sqrt{{k}_{St}^{2} + {μ}_{0} iωσ} , {μ}_{0} = 4 π \cdot {10}^{- 7} henry \text{/} m , \\ {k}_{St} \approx ω \sqrt{{ρ}_{b} ( \frac{1}{{K}_{b}} + \frac{1}{δ G} + \frac{2}{δ W {r}_{b}} )} , \\ W = ( \frac{η \sqrt{iω {c}_{D}}}{{κ}_{0}} ) \frac{{K}_{0} ( {r}_{b} \sqrt{iω / {c}_{D}} )}{{K}_{1} ( {r}_{b} \sqrt{iω / {c}_{D}} )} . \qquad ( 1 )$$

From this point, (∈₀ ∈_{f}) is the dielectric permittivity of pore fluid; ζ is the value of zeta potential;

η is the viscosity of pore fluid; κ₀ is the formation permeability; M_{b}∈[1,2]; ω=2πf is circular frequency;

$${ω}_{b} = \frac{φη}{{α}_{∞} {ρ}_{f} {κ}_{0}}$$

is Biot's frequency, ρ_{f} is the density of pore fluid; ρ_{b} is the density of borehole fluid; δ=1−(r_{d}/r_{b})², r_{b} is the borehole radius, r_{d} is the AEMLD radius; σ=φ(σ_{f}-σₛ)/α_{∞}+σₛ is the formation conductivity, σ_{f} is the conductivity of pore fluid, σₛ is the frame conductivity; σ_{b} is the mud conductivity;

$${c}_{D} = \frac{{κ}_{0}}{η} ( \frac{M B}{B + M {a}^{2}} )$$

is the diffusion constant, M=(φ/k_{f}+(1−φ−χ)/kₛ)⁻¹, a=1−χ,

$$B = K + \frac{4}{3} G ,$$

χ=K/kₛ, K, G are the bulk and shear module of dry frame, kₛ is the bulk module of frame material; K_{b}—the bulk module of borehole fluid; k_{f} is the bulk module of pore fluid, Iₙ and Kₙ denote the modified Bessel function of the first and second kind of the n-th order. For typical formation parameters, I_{c}^{H} is a practically real function for frequencies greater then 100 Hz.

From expression (1) the simple approximate formula for HP(f) follows

$$HP ( f ) = \frac{Re ( R )}{Im ( R )} \approx \frac{ω}{{M}_{b} {ω}_{b}} = 2 π \frac{{α}_{∞} {ρ}_{f} {κ}_{0}}{{M}_{b} φη} f . \qquad ( 2 )$$

For R_{E}(ω) we have the following expression

$${R}_{E} \approx - i \frac{φ}{{α}_{∞}} \frac{{ɛ}_{0} {ɛ}_{f} ζ}{η} ( 1 - \frac{i}{{M}_{b}} \frac{ω}{{ω}_{b}} ) {I}_{c}^{E} , \\ where {I}_{c}^{E} \approx \frac{{k}_{St}}{\frac{1}{2} {σ}_{b} {k}_{fe} {r}_{b} {K}_{0} ( {k}_{fe} {r}_{b} ) / {K}_{1} ( {k}_{fe} {r}_{b} ) + σ} . \qquad ( 3 )$$

For typical formation parameters, I_{c}^{E} is also

a practically real function for frequencies greater then 100 Hz, and as corollary fact we have

$$EP ( f ) = \frac{Re ( {R}_{E} )}{Im ( {R}_{E} )} \approx \frac{ω}{{M}_{b} {ω}_{b}} = 2 π \frac{{α}_{∞} {ρ}_{f} {κ}_{0}}{{M}_{b} φη} f . \qquad ( 4 )$$

For sealed pores:

$${R}_{H} ( ω ) \approx - i \frac{φ}{{α}_{∞}} \frac{{ɛ}_{0} {ɛ}_{f} ζ}{η} ( 1 - \frac{1}{{M}_{b}} \frac{iω}{{ω}_{b}} ) {I}_{c}^{H} ( 1 - γ \frac{U - Y}{U - Z} ) ( \frac{{ρ}_{f}}{2 ρ} \frac{{υ}^{2}}{( U - ( 1 - {υ}^{2} ) X ) ( U - Z )} ) , \qquad ( 5 )$$

where I_{c}^{H} is defined above, and

$$HP ( f ) \approx 2 π \frac{{α}_{∞} {ρ}_{f} {κ}_{0}}{{M}_{b} φη} f + A \cdot ( Re \overline{Y} - Im \overline{Y} ) ( 1 + \frac{B + {a}^{2} M}{a M} \cdot \frac{{ρ}_{f}}{ρ} ( 1 - \frac{Z}{U} ) ) . \\ Here A = {( 1 - 2 U {r}_{b} \sqrt{\frac{π f η ( B + {a}^{2} M )}{{κ}_{0} M B}} )}^{- 1} , U = \frac{{K}_{0} ( {k}_{p +} {r}_{b} )}{( {k}_{p +} {r}_{b} ) {K}_{1} ( {k}_{p +} {r}_{b} )} , {k}_{p +} = \sqrt{{k}_{St}^{2} - \frac{{ω}^{2}}{{C}_{+}^{2}}} ; \\ \overline{Y} = \frac{{K}_{0} ( {k}_{-} {r}_{b} )}{{K}_{1} ( {k}_{-} {r}_{b} )} , Y = \frac{\overline{Y}}{{k}_{-} {r}_{b}} , {k}_{-} = \sqrt{\frac{iω}{{c}_{D}}} , γ = ( \frac{a M}{B + {a}^{2} M} ) \frac{ρ}{{ρ}_{f}} , ρ = ( 1 - φ ) {ρ}_{s} + φ \cdot {ρ}_{f} , Z = \frac{{K}_{0} ( {k}_{fe} {r}_{b} )}{( {k}_{fe} {r}_{b} ) {K}_{1} ( {k}_{fe} {r}_{b} )} , {k}_{fe} = \sqrt{{k}_{St}^{2} + {μ}_{0} iωσ} , X = \frac{{K}_{0} ( {k}_{s} {r}_{b} )}{( {k}_{s} {r}_{b} ) {K}_{1} ( {k}_{s} {r}_{b} )} , {k}_{St} = ω / {V}_{St} , {V}_{St} = {( {ρ}_{b} ( \frac{1}{{K}_{b}} + \frac{1}{δ G} ) )}^{\frac{1}{2}} , υ = \frac{{V}_{St}}{{C}_{sh}} , {k}_{s} = {k}_{St} \sqrt{1 - {υ}^{2}} , {C}_{+} = \sqrt{\frac{B + M {a}^{2}}{ρ}} , {C}_{sh} = \sqrt{\frac{G}{ρ}} , \qquad ( 6 )$$

where C₊-phase velocity of P-wave, Cₛₕ—phase velocity of S-wave, V_{St}—phase velocity of Stoneley (St) wave, ρₛ—density of the frame material, and ρ—density of formation.

For R_{E}(ω) we have the following expression

$$\begin{matrix}{R}_{E} \approx - i \frac{φ}{{α}_{∞}} \frac{{ɛ}_{0} {ɛ}_{f} ζ}{η} ( 1 - \frac{1}{{M}_{b}} \frac{iω}{{ω}_{b}} ) {I}_{c}^{E} ( 1 - γ \frac{U - Y}{U - Z} ) ( \frac{{ρ}_{f}}{2 ρ} \frac{{υ}^{2}}{( U - ( 1 - {υ}^{2} ) X ) ( U - Z )} ) , & ( 7 ) \\ and & \\ EP ( f ) \approx 2 π \frac{{α}_{∞} {ρ}_{f} {κ}_{0}}{{M}_{b} φη} f + A \cdot ( Re \overline{Y} - Im \overline{Y} ) ( 1 + \frac{B + {a}^{2} M}{a M} \cdot \frac{{ρ}_{f}}{ρ} ( 1 - \frac{Z}{U} ) ) . & ( 8 )\end{matrix}$$

From the above is evident, that the expressions for HP(f) and EP(f) coincide for cases of open and sealed pores respectively.

For derivation of the above-stated relations, the following general assumptions have been made:

the low-frequency case is considered, i.e. frequencies considerably less than Biot's frequency;

the borehole fluid surrounding AEMLD (r∈(r_{d},r_{b})) is considered as a compressible nonviscous fluid with given density ρ_{b}, bulk modulus K_{b}, conductivity ρ_{b} and relative dielectric permeability ∈_{b}. It is assumed that displacement current is more less conduction current in mud. The formation surrounding the borehole (r>r_{b}) is a uniform porous medium saturated by a fluid electrolyte.

it is assumed that dielectric permeability and conductivity of AEMLD are the same as of borehole fluid. This assumption is justified, if the AEMLD is isolated electrically from borehole fluid (its earthed conductive metal housing (downhole sonde housing) is covered with a dielectric layer) and its radius is much less than the length of electromagnetic wave in insulating coating. This condition is always fulfilled for frequencies in acoustic range.

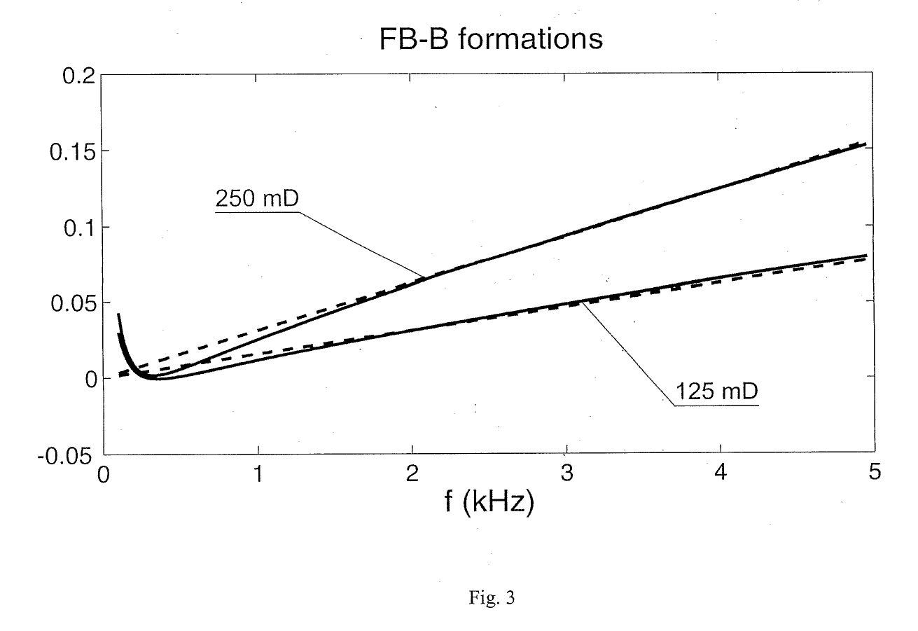

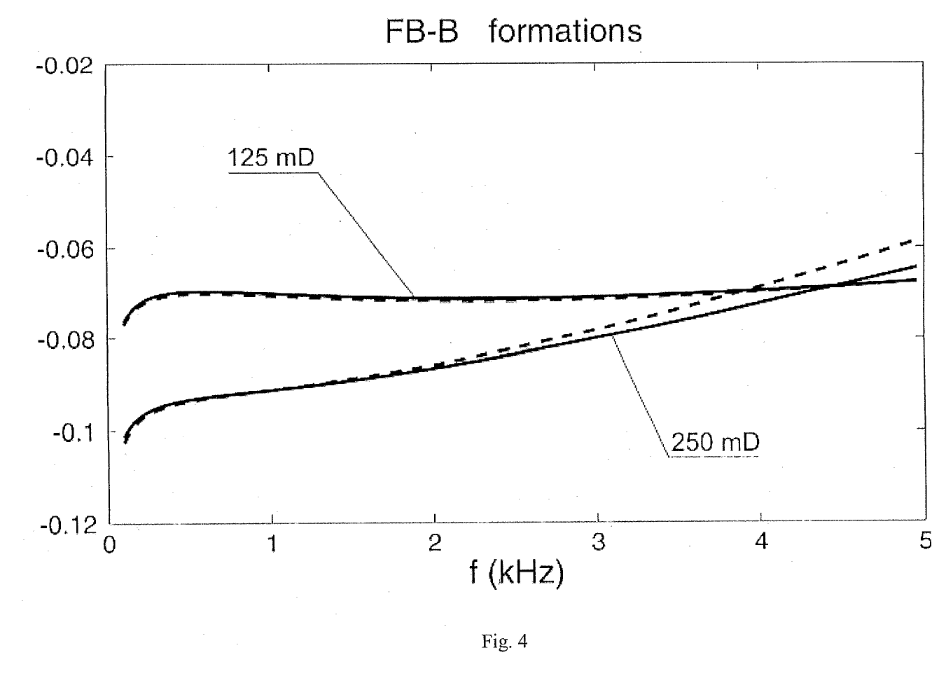

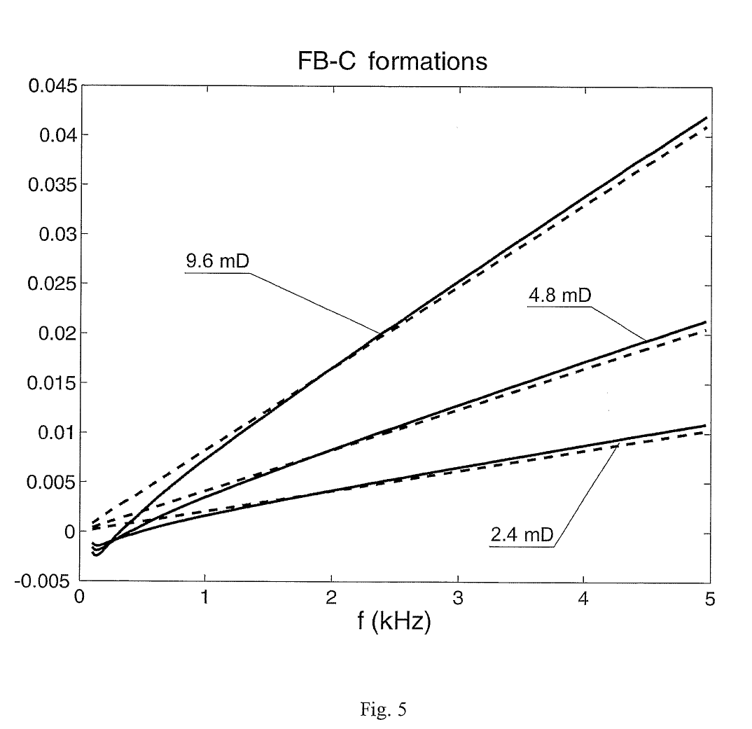

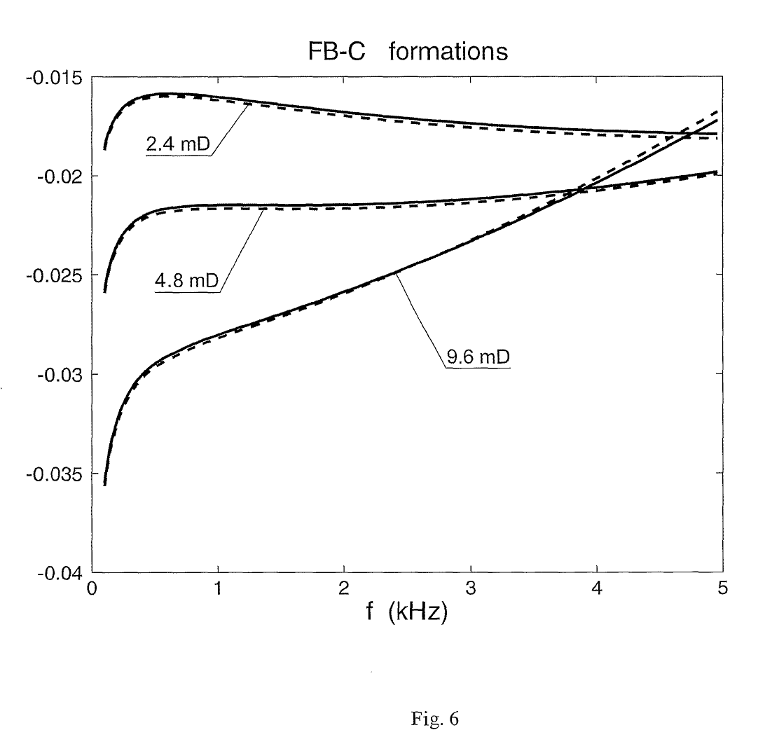

In FIGS. 3, 4, 5 and 6 HP(f) curves are shown, which are plotted based on the results of calculations by means of the PSRL code (continuous line), and the formulas for open pores (2) and for sealed pores (6) (dashed line). The PSRL code is described in B. D. Plyushchenkov and V. I. Turchaninov, “Solution of Pride's equations through potentials,” Int. J. Mod. Phys. C, 17, 6, 877-908 (2006). These calculations have been carried out for permeable formations (Fontainebleau-B sandstones (FB-B) for κ₀=125, 250 mD) and for weakly permeable formations (Fontainebleau-C sandstones (FB-C) for κ₀=2.4, 4.8, 9.6 mD). Input data for these calculations are presented in Table 1. HP (f) curves for the case of open pores, for FB-B formations are shown in FIG. 3 and for FB-C formation—in FIG. 5. FIG. 4 and FIG. 6 correspond to the case of sealed pores for the same formations. In all cases there is a very good agreement between the approximate analytical expressions (2) and (6) and analogous curves obtained by the PSRL code that solves the full system of Pride's equations.

So a new method for estimating fluid permeability (or mobility m=κ₀/η, where κ₀ is the formation permeability, η is the viscosity of pore fluid) of an earth formation from joint measurements of acoustic waves and electromagnetic waves generated in response to them is proposed and includes the following steps:

the first step of the method consists in the joint measurement of pressure field P(t) and electromagnetic field (H^{θ}(t) and E^{z}(t));

the second step includes the preprocessing of the measured data in order to separate components from said measured acoustic response signals and said measured electromagnetic signals representing Stoneley waves propagating through said formation by separating the complex-valued spectra of Stoneley wave of acoustic and electromagnetic response from the other phases. This will allow to compute the measured EP(f) and HP(f) ratio. The preprocessing may be accomplished, for instance, by a TKO decomposition algorithm, described in M. P Ekstrom, “Dispersion estimation from borehole acoustic arrays using a modified matrix pencil algorithm”, presented at 29-th Asilomar Conference on Signals, Systems, and Computers, Pacific Grove, CA, Oct. 31, 1995, pp. 5;

the last step includes the finding of the best values of the permeability (mobility) to adjust the analytic curves HP(f) and EP(f); (2) and (4) in absence of mudcake or (6), (8) in the case of the presence of the mudcake, to the measured curve HP(f) and EP(f) obtained in the second step. Initially, the analytical curves are synthesized using some initial values of the mobility. The initial value of mobility is adjusted iteratively, and the steps are repeated until the misfit reaches a minimum value (trial-and-error method or inversion). It is assumed that all parameters in (2)-(4) or (6)-(8) are known by other logging measurements.

While the invention has been described with respect to a limited number of embodiments, those skilled in the art will devise other embodiments of this invention which do not depart from the scope of the invention as disclosed therein. Accordingly the scope of the invention should be limited only by the attached claims.

TABLE 1

| Borehole, mud and tool parameters | | # 1 | # 2 |
|---|---|---|---|
| borehole radius | r_{b} (m) | 0.12 | 0.12 |
| tool radius | r_{d} (m) | 0.05 | 0.05 |
| ε of tool | ε_{d} | 3. | 3. |
| tool conductivity | σ_{d} (Ω⁻¹ · m⁻¹) | 0. | 0. |
| mud density | ρ_{b} (kg · m⁻³) | 1.2 · 10³ | 1.2 · 10³ |
| mud bulk module | K_{b} (N · m⁻²) | 2.7 10⁹ | 2.7 10⁹ |
| mud ε | ε_{b} | 70. | 70. |
| mud conductivity | σ_{b} (Ω⁻¹ · m⁻¹) | 0.5 | 0.5 |
| Parameters of main formation | | FB-B | FB-C |
| fluid density | ρ_{f} (kg · m⁻³) | 1 · 10³ | 1 · 10³ |
| fluid bulk module | k_{f} (N · m⁻²) | 2.25 · 10⁹ | 2.25 · 10⁹ |
| fluid viscosity | η (N · sec · m⁻²) | 0.001 | 0.001 |
| ε of fluid | ε_{f} | 80. | 80. |
| fluid conductivity | σ_{f} (Ω⁻¹ · m⁻¹) | 0.1 | 0.1 |
| zeta potential | ζ (V = volt) | −0.07 | −0.06 |
| Debye length | d (m) | 1 · 10⁻⁹ | 1 · 10⁻⁹ |
| porosity | φ | 0.168 | 0.067 |
| frame density | ρₛ (kg · m⁻³) | 2.64 · 10³ | 2.63 · 10³ |
| frame bulk module | kₛ (N · m⁻²) | 3.9 · 10¹⁰ | 3.9 · 10¹⁰ |
| shear module of dry | G (N · m⁻²) | 2.34 · 10¹⁰ | 3.19 · 10¹⁰ |
| frame | | | |
| bulk cementation | χ | 0.82 | 0.93 |
| factor | | | |
| frame ε | εₛ | 4.5 | 4.5 |
| tortuosity | α_{∞} | 3.33 | 9.18 |
| M_{b} | M_{b} | 1. | 1. |
| permeability | κ₀ (darcy (D) = | 0.125, | 0.0024, |
| | 1 · 10⁻¹² m²) | 0.25, 0.5 | 0.0048, |
| | | | 0.0096 |

1. A method for estimating permeability of a formation, the method comprising:
exciting the formation with acoustic energy pulses propagating into said formation, said acoustic energy pulses comprise Stoneley waves;
measuring the acoustic response signals produced by the acoustic exciting;
measuring the electromagnetic signals produced by said acoustic energy pulses within the formation;
separating components from said measured acoustic response signals and said measured electromagnetic signals representing Stoneley waves propagating through said formation;
selecting initial value of permeability;
calculating synthesis acoustic response signals and synthesis electromagnetic signals representing Stoneley waves propagating through said formation using said initial value of the permeability;
determining a difference between said separated acoustic response signal and electromagnetic signal components and said synthesized Stoneley wave signals;
adjusting said initial value of said permeability and repeating said steps of calculating said synthesis acoustic response signals and synthesis electromagnetic signals representing Stoneley waves propagating through said formation, determining said difference and adjusting said value of said permeability until said difference reaches a minimum.

2. The method of claim 1, wherein the acoustic energy pulses are generated at a logging tool positioned within a borehole surrounded by the formation.

3. The method of claim 1, wherein the electromagnetic signals are magnetic signals.

5. The method of claim 1, wherein the electromagnetic signals are electric signals.

6. The method of claim 1, wherein the electromagnetic signals are both magnetic signals and electric signals.

7. The method of claim 1, wherein said acoustic energy pulses further comprise compressional waves.

8. The method of claim 1, wherein said acoustic energy pulses further comprise shear waves.

9. The method of claim 1, wherein said acoustic energy pulses further comprise both compressional waves and shear waves.

10. A system for estimating permeability of a formation surrounding a borehole, a system comprising:
a logging tool to be lowered into the borehole comprising at least one acoustic energy source located on said logging tool, the acoustic energy source allowing to excite the formation with the acoustic energy pulses propagating within the formation, said acoustic energy pulses comprise Stoneley waves, an array of acoustic receivers to measure the acoustic response signals produced by the acoustic energy pulses within the formation, an array of electromagnetic receivers to measure the electromagnetic signal produced by the acoustic energy pulses within the formation;
processing means to analyze the measured signals so as to estimate the permeability of the formation.

11. The system of claim 10, wherein said acoustic energy pulses further comprise compressional waves.

12. The system of claim 10, wherein said acoustic energy pulses further comprise shear waves.

13. The system of claim 10, wherein the electromagnetic receiver is a magnetic receiver allowing to measure a magnetic signal produced by the acoustic energy pulses within the formation.

14. The system of claim 10, wherein the electromagnetic receiver is an electric receiver allowing to measure an electric signal produced by the acoustic energy pulses within the formation.

15. The system of claim 10, wherein the electromagnetic receiver consists of an electric receiver allowing to measure an electric signal produced by the acoustic energy pulses within the formation and a magnetic receiver allowing to measure a magnetic signal produced by the acoustic energy pulses within the formation.

16. The system of claim 14, wherein said electric receivers are electrodes.

17. The system of claim 13, wherein said magnetic receivers are coils.

18. A logging tool for estimating permeability of a formation surrounding a borehole, a tool comprising:
an elongated mandrel covered by an insulated material or made with a non-conductive material;
at least one low-frequency monopole and an array of pressure sensors and coils with ferrite cores positioned at axially spaced apart locations along the mandrel and separated by means of acoustic and electric insulators, the coils having shape of series-connected toroid pieces disposed in a circle around the mandrel;
the electrodes positioned at axially spaced apart locations from the acoustic energy source so that pressure sensors are disposed in the middle between two adjacent electrodes.

19. The logging tool of claim 18, wherein the coils are disposed between azimuthally equally spaced pressure sensors.

20. The logging tool of claim 18, further comprising a high frequency monopole.

21. The logging tool of claim 18, further comprising a dipole emitter.

22. The logging tool of claim 18, wherein the distance in the circle between the neighboring ends of ferrite cores is more than diameter of pressure sensors and the ferrite core radius is more than the height on which these sensors tower above the surface of the tool.

23. The logging tool of claim 18, wherein only a portion of the mandrel on which the electrodes are disposed is covered by an insulated material or made with a non-conductive material.

24. The logging tool of claim 18, further comprising a nuclear logging block disposed below the acoustic transmitter.
